(19) United States
(12) Patent Application Publication
(10) Pub. No.: US 2004/0012961 A1
(43) Pub. Date: Jan. 22, 2004

(54) Light bulb assembly for a light string with a light bulb enclosed in a casing

(76) Inventor: Tsui-Tuan Fan Wong, Hsitzu City (TW)

Correspondence Address: Cooper & Dunham LLP, 1185 Avenue of the Americas, New York, NY, 10036, US

(21) Appl. No.: 10/198,588

(22) Filed: Jul. 17, 2002

(51) Int. Cl. F21V 21/00

(52) U.S. Cl. 362/249

(57) ABSTRACT

A light bulb assembly for a light string has a light bulb with two electrical wires extending out of the light bulb, a spacer positioned between the two electrical wires to separate the two electrical wires, two cables respectively connected to the electrical wires, a casing having a chamber defined to receive and enclose therein the light bulb, the electrical wires, the spacer and the cables, a water resistant gel inserted into the chamber of the casing to allow the light bulb, the electrical wires, the spacer and a portion of each of the cables to become an integral body, and a membrane enclosing the casing. The light bulb assembly has excellent water resistant capability.

### BACKGROUND OF THE INVENTION

1. Field of the Invention

The present invention relates to a light bulb assembly for a light string, and more particularly to a light bulb assembly for a light string with a light bulb completely received in a casing of the light bulb assembly so that each light bulb assembly has excellent water proof capability.

2. Description of Related Art

Light string structures have been described in many patents to overcome different kinds of problems. Some patents discuss the use of a spacer to separate two electrical wires to accomplish the purpose of preventing water from seeping into the rope structure. Some patents discuss the use of a membrane to enclose the light bulb so that the light bulb is protected from the environment. However, no matter the spacer or the membrane is used, because the water prevention effectiveness by using the spacer is not as good as expected so that the conventional existing rope structure has to be improved to enhance water prevention effectiveness.

To overcome the shortcomings, the present invention tends to provide an improved light bulb assembly light string structure to mitigate and obviate the aforementioned problems.

### SUMMARY OF THE INVENTION

The primary objective of the present invention is to provide an improved light bulb assembly having a light bulb with two electrical wires extending out of the light bulb, a spacer positioned between the two electrical wires, two cables respectively connected to the electrical wires, a casing enclosing the light bulb, the spacer and a portion of the cables and a membrane enclosing the casing, the light bulb, the spacer and a portion of the cables. With such an arrangement, the light bulb assembly has excellent water proof capability.

Another objective of the present invention is that a water resistant gel is inserted into the casing to allow the bulb, the spacer, the electrical wires and the cables to become an integral body.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view showing parts of the light bulb assembly of the present invention;

FIG. 2 is a cross sectional view showing the inner structure of the light bulb assembly of the present invention; and

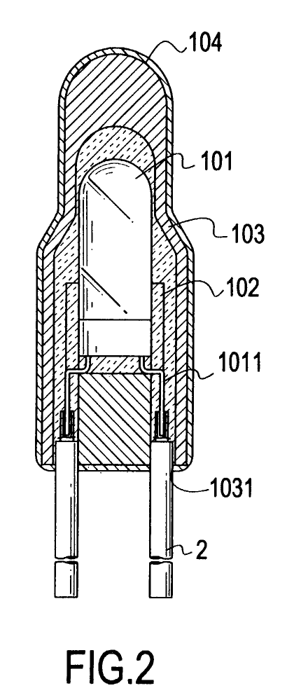

FIG. 3 shows different embodiments of the casing of the present invention.

### DETAILED DESCRIPTION OF THE PREFERRED EMBODIMENT

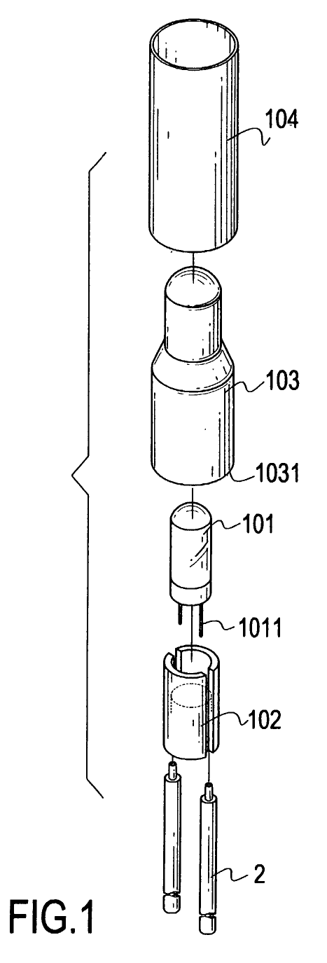

With reference to FIG. 1, the light bulb assembly for a light string and in accordance with the present invention has a light bulb (101) and provided with two electrical wires (1011) extending out of the light bulb (11), a spacer (102) positioned between the two electrical wires (1011) and having two recesses (1021) oppositely defined in a periphery of the spacer (102) to respectively correspond to one of the electrical wires (1011), two cables (2) respectively connected to a corresponding one of the electrical wires (1011), a casing (103) having a chamber (1031) defined therein to receive the light bulb (101), the spacer (102) and a portion of each of the cables (2) and a membrane (104) completely enclosing the casing (103), the light bulb (101), the electrical wires (1011), the spacer (102) and a portion of each of the two cables (2).

When the parts in FIG. 1 are to be assembled, the spacer (102) is inserted between the electrical wires (1011) with the two electrical wires (1011) received in the corresponding recess (1021) and the cables (2) are respectively connected to the corresponding electrical wire (11). Then, the combination of the light bulb (101), the electrical wires (1011), the spacer (102) and the cables (2) are inserted into the casing (103). Finally, the membrane (104) is applied to enclose the combination of the casing (103), the light bulb (101), the spacer (102) and a part of each of the cables (2).

After the combination is entirely inserted into the casing (103), a water resistant gel (105) is inserted into the casing (103) to allow the combination to become an integral body. With such an arrangement, water resistant of the light bulb assembly of the present invention is greatly increased.

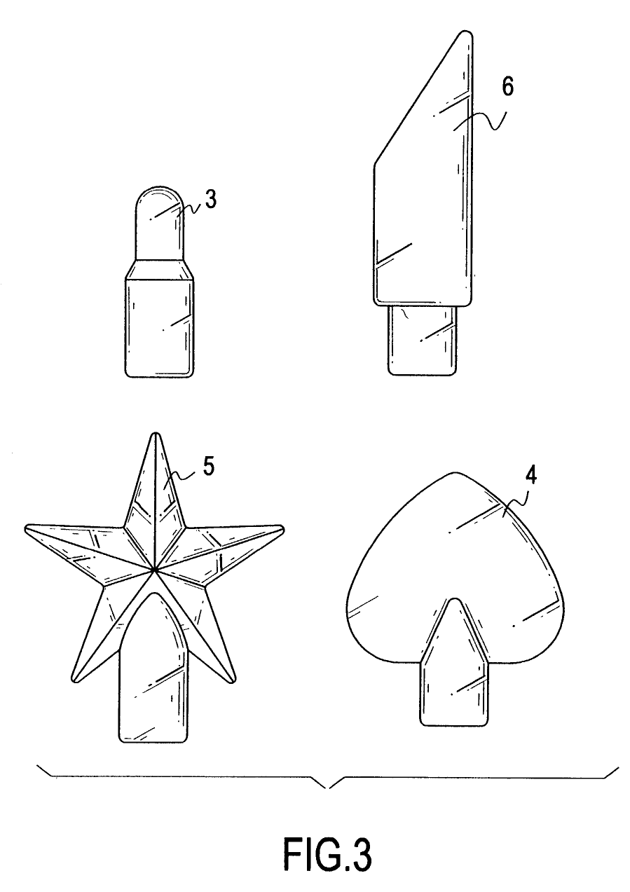

With reference to FIG. 3, it is noted that the casing (103) may be configured to have shapes such as a bullet (3), a heart (4), a star (5) and tube with a truncated portion (6). That is, the shape of the casing (103) can be any shape as required so as to meet the user's requirement.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light bulb assembly for a light string, the light bulb assembly comprising:
a light bulb with two electrical wires extending out of the light bulb;
a spacer positioned between the two electrical wires to separate the two electrical wires;
two cables respectively connected to a corresponding one of the electrical wires;
a casing having a chamber defined to receive and enclose therein the light bulb, the electrical wires, the spacer and the cables;
a water resistant gel inserted into the chamber of the casing to allow the light bulb, the electrical wires, the spacer and a portion of each of the cables to become an integral body; and
a membrane enclosing the casing,
whereby the light bulb assembly has excellent water resistant capability.

2. The light bulb assembly as claimed in claim 1, wherein the spacer has two recesses oppositely defined in a periphery of the spacer to correspond to the two electrical wires.

3. The light bulb assembly as claimed in claim 1, wherein the casing has a bullet shape.

4. The light bulb assembly as claimed in claim 1, wherein the casing has a heart shape.

5. The light bulb assembly as claimed in claim 1, wherein the casing has a star shape.

6. The light bulb assembly as claimed in claim 1, wherein the casing is a tube with a truncated portion.
